(19) United States
(12) Patent Application Publication
(10) Pub. No.: US 2022/0086006 A1
(43) Pub. Date: Mar. 17, 2022

(54) COMPUTER-IMPLEMENTED SYSTEM AND METHOD FOR ASSET MIXING

(71) Applicant: nChain Holdings Limited, St. John's (AG)

(72) Inventors: Pauline BERNAT, London (GB); Silvia BARTOLUCCI, London (GB)

(21) Appl. No.: 17/262,658

(22) PCT Filed: Jul. 17, 2019
(86) PCT No.: PCT/IB2019/056105

§ 371 Date: Jan. 22, 2021

(30) Foreign Application Priority Data
Jul. 23, 2018 (GB) 1811968.5

(51) Int. Cl. H04L 9/32; G06F 16/23; G06F 16/22; G06Q 20/40; G06Q 20/36

(52) U.S. Cl. CPC H04L 9/3239; G06F 16/2379; G06F 16/2246; H04L 2209/56; G06Q 20/36; H04L 2209/38; G06Q 2220/00; G06Q 20/401

(57) ABSTRACT

An asset mixing protocol allows a group of participant computer systems to mix their assets using a set of asset mixing transactions created in such a way that a given participant computer system may have input and output addresses included in different asset mixing transactions. The use of quantities derived from an accumulation tree allows the protocol to securely condition the redeeming of the deposit made by the participant computer systems to the broadcast of all asset mixing transactions on the blockchain. Safeguards are provided that protect against a central coordinator or dealer possessing enough information to steal assets from the participant computer systems.

### TECHNICAL FIELD

This disclosure relates generally to the generation and performance of an atomic operation through the use of a plurality of non-atomic operations recorded on a blockchain. The disclosure is particularly suited but not limited to the performance of a synthetic atomic operation that involves contributions from a plurality of participants. In general, the disclosure uses an accumulation tree to assure individual participants that, in the event of failure of the atomic operation, any individual contributions will be returned.

### BACKGROUND

In this document the term “blockchain” refers to any of several types of electronic, computer-based, distributed ledgers. These include consensus-based blockchain and transaction-chain technologies, permissioned and unpermissioned ledgers, shared ledgers and variations thereof. The most widely known application of blockchain technology is the Bitcoin ledger, although other blockchain implementations have been proposed and developed. While the example of Bitcoin may be referred to in the present disclosure, for the purpose of convenience and illustration it should be noted that the disclosure is not limited to use with the Bitcoin blockchain, and alternative blockchain implementations and protocols fall within the scope of the present disclosure. For example, the disclosure can be useful in other blockchain implementations that have limitations similar to Bitcoin regarding what constraints can be encoded within transactions.

A blockchain is a peer-to-peer, electronic ledger that is implemented as a computer-based decentralised, distributed system made up of blocks which, in turn, are made up of transactions and other information. For example, with Bitcoin each transaction is a data structure that encodes the transfer of control of a digital asset between participants in the blockchain system and includes at least one input and at least one output. In some embodiments, a “digital asset” refers to binary data that is associated with a right to use. In some implementations, transferring control of a digital asset can be performed by reassociating at least a portion of a digital asset from a first entity to a second entity. Each block contains a hash of the previous block so that blocks become chained together to create a permanent, immutable record of all transactions that have been written to the blockchain since its inception. Transactions contain small programs known as scripts embedded into their inputs and outputs that specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid transactions rejected from the network. A node can have standards for validity different from other nodes. Because validity in the blockchain is consensus-based, a transaction is considered valid if a majority of nodes agree that a transaction is valid. Software clients installed on the nodes perform this validation work on transactions referencing an unspent transaction (UTXO) in part by executing the UTXO locking and unlocking scripts. If execution of the locking and unlocking scripts evaluates to TRUE and other validation conditions, if applicable, are met, the transaction is validated by the node. The validated transaction is propagated to other network nodes, whereupon a miner node can select to include the transaction in a blockchain. Thus, in order for a transaction to be written to the blockchain, it must be i) validated by the first node that receives the transaction—if the transaction is validated, the node relays it to the other nodes in the network; and ii) added to a new block built by a miner; and iii) mined, i.e., added to the public ledger of past transactions. The transaction is considered to be confirmed when a sufficient number of blocks is added to the blockchain to make the transaction practically irreversible.

Although blockchain technology is most widely known for the use of cryptocurrency implementation, digital entrepreneurs have begun exploring the use of both the cryptographic security system Bitcoin is based on and the data that can be stored on the blockchain to implement new systems. It would be highly advantageous if the blockchain could be used for automated tasks and processes which are not limited to the realm of cryptocurrency. Such solutions would be able to harness the benefits of the blockchain (e.g., a permanent, tamper-proof record of events, distributed processing, etc.) while being more versatile in their applications.

A blockchain transaction output includes a locking script and information regarding ownership of digital assets such as Bitcoins. The locking script, which may also be referred to as an encumbrance, “locks” the digital assets by specifying conditions that are required to be met in order to unlock the output. For example, a locking script could require that certain data be provided in an unlocking script to unlock the associated digital assets. The locking script is also known as “scriptPubKey” in Bitcoin. A technique for requiring a party to provide data to unlock a digital asset involves embedding a hash of the data inside the locking script. However, this presents a problem if the data is undetermined (e.g., not known and fixed) at the time the locking script is created.

### SUMMARY

Thus, it is desirable to provide methods and systems that improve blockchain technology by providing a method for performing atomic transactions using combinations of distinct non-atomic transactions. Such an improved solution has now been devised. Thus, in accordance with the present disclosure there is provided a method as defined in the appended claims.

Thus, it is desirable to provide a computer-implemented method, the computer-implemented method comprising: generating a data structure that cryptographically identifies a set of participant computer systems in an output-shuffling process; acquiring, from the set of participant computer systems, a set of shuffled output addresses; determining that a set of contribution records, such as a set of deposit transactions, corresponding to the set of participant computer systems has been committed to a blockchain; generating a plurality of asset mixing transactions based at least in part on the set of shuffled output addresses and the data structure; and submitting the plurality of asset mixing transactions to the blockchain.

Preferably, the computer-implemented method claimed may be an embodiment further comprising determining, after a first timeout, that an individual asset mixing transaction associated with an individual participant computer system has failed; and as a result of determining that an individual asset mixing transaction has failed, providing cryptographic information to the individual participant computer system that allows the individual participant computer system to claim compensation from the set of contribution records, or reclaim the contribution record of the individual participant computer system.

Preferably, the computer-implemented method claimed may be an embodiment where each set of contribution records includes a locking script, and the locking script allows a transaction output to be claimed by an individual participant computer system based on the set of shuffled output addresses.

Preferably, the computer-implemented method claimed may be an embodiment where the locking script allows an input to be reclaimed using the cryptographic information.

Preferably, the computer-implemented method claimed may be an embodiment where the locking script allows an input to be reclaimed after a second timeout, the second timeout being greater than the first timeout.

Preferably, the computer-implemented method claimed may be an embodiment where the locking script includes an OP_CHECKSEQUENCEVERIFY operator.

Preferably, the computer-implemented method claimed may be an embodiment where the set of shuffled output addresses is acquired by causing a set of shuffled output addresses to be routed to each participant computer system in the set of participant computer systems.

Preferably, the computer-implemented method claimed may be an embodiment where each contribution record in the set of contribution records includes a transaction fee paid to a dealer that facilitates the computer-implemented method.

Preferably, the computer-implemented method claimed may be an embodiment where the data structure is an accumulation tree where leaf nodes of the accumulation tree represent the set of participant computer systems.

Preferably, the computer-implemented method claimed may be an embodiment where participant computer systems in an individual asset mixing transaction correspond to the leaf nodes under an intermediate node of the accumulation tree.

Preferably, the computer-implemented method claimed may be an embodiment where each participant computer system provides a hash of a value associated with each leaf node of the accumulation tree.

Preferably, the computer-implemented method claimed may be an embodiment where the asset mixing transaction is an asset mixing transaction.

Preferably, the computer-implemented method claimed may be an embodiment where each participant computer system is a computer system having one or more processors and memory storing instructions that, as a result of being executed by the one or more processors, implement a cryptocurrency wallet application.

It is also desirable to provide a system, comprising: a processor; and memory including executable instructions that, as a result of execution by the processor, causes the system to perform any of the methods as claimed.

It is also desirable to provide a non-transitory computer-readable storage medium having stored thereon executable instructions that, as a result of execution by one or more processors of a computer system, cause the computer system to at least perform any of the methods as claimed.

The disclosure can be described as a verification method/system, and/or as a control method/system for controlling the exchange or transfer of a digital asset via a blockchain. In some embodiments, the digital asset is a token or a portion of cryptocurrency. As explained below, the disclosure can also be described as a secure method/system for new, improved and advantageous ways of performing operations via a blockchain network or platform.

### BRIEF DESCRIPTION OF THE DRAWINGS

These and other aspects of the present disclosure will be apparent from and elucidated with reference to the embodiment described herein. An embodiment of the present disclosure will now be described, by way of example only and with reference to the accompanying drawings, in which:

FIG. 1 illustrates an example of a system that performs asset mixing, in an embodiment;

FIG. 2 illustrates an example of an accumulation tree for a set of nine elements, in an embodiment;

FIG. 3 illustrates an example of an accumulation tree where each leaf node has an associated element eᵢ for i=1 . . . 4, in an embodiment;

FIG. 4 illustrates an example of an encryption operation performed as part of a multi-CoinJoin transaction, in an embodiment;

FIG. 5 illustrates an example of a decryption operation performed as part of a multi-CoinJoin transaction, in an embodiment;

FIG. 6 illustrates an example of a reordering of output addresses performed as part of a multi-CoinJoin transaction, in an embodiment;

FIG. 7 illustrates an example of a locking Script generated by a participant for a deposit as part of a multi-CoinJoin transaction, in an embodiment;

FIG. 8 illustrates an example of contribution records created, signed and broadcast by four participants in a multi-CoinJoin transaction, in an embodiment;

FIG. 9 illustrates an example of two CoinJoin transactions created and signed by participants in a multi-CoinJoin transaction, in an embodiment;

FIG. 10 illustrates an example of a process that, as a result of being performed by a dealer computer system and one or more participant computer systems, performs a multi-CoinJoin transaction, in an embodiment;

FIG. 11 illustrates an example of a process that, as a result of being performed by a dealer computer system and one or more participant computer systems, performs a key exchange and builds an accumulator tree for use in a multi-CoinJoin transaction, in an embodiment;

FIG. 12 illustrates an example of a process that, as a result of being performed by a dealer computer system and one or more participant computer systems, rearranges output addresses, generates deposits, and creates CoinJoin transactions for a multi-CoinJoin transaction, in an embodiment;

FIG. 13 illustrates an example of a process that, as a result of being performed by a dealer computer system and one or more participant computer systems, processes returns and compensation for a multi-CoinJoin transaction, in an embodiment; and

FIG. 14 illustrates a computer system in which various embodiments can be implemented.

### DESCRIPTION OF EMBODIMENTS

The present document describes a system that performs a security method to perform an atomic operation using a combination of non-atomic transactions recorded on a blockchain. In an embodiment, the system identifies a dealer computer system and a set of participant computer systems. In coordination with the participant computer systems, the dealer generates an accumulation tree which is used to generate cryptographic information specific to each participant that is provided to the participant computer systems. Each participant computer system generates a transaction that commits resources to the atomic operation, where the transaction is secured with a locking script based at least in part on the cryptographic information. In various examples, the resources may be a cryptographic key, code, quantity of cryptocurrency, unspent transaction output. In an embodiment, the locking script provides for redemption of the transaction input after a timeout in the event that the atomic operation fails for any reason. The dealer computer system determines whether all of the participants have properly fulfilled their resources to the atomic operation, and if so, generates and commits a plurality of transactions to the blockchain that, in aggregate effect, perform the atomic operation. In the event that not all of the participant computer systems have committed the necessary resources to complete the atomic operation, the dealer computer system provides specific information associated with the accumulation tree that allows the participant computer systems to recover their committed resources. In this way, the participants are able to obtain cryptographic assurance that either the atomic operation will be completed, or that any resources committed to the effort will be returned.

In some examples, the system may be used to improve the effectiveness of an asset mixing operation by allowing a single asset mixing operation to span a plurality of transactions on a blockchain. For an asset mixing transaction, the exclusion of personal information from the destination addresses does not necessarily obscure the identity of the participants in the transaction. A highly motivated individual may utilise the transaction information in a publicly available ledger, along with external datasets, to perform analyses capable of relating individuals to specific transfers and destination addresses. Embodiments described herein alleviate this concern by splitting a single asset mixing operation into multiple component transactions. The asset mixing system described herein is also applicable to various problems where exchanges may be made in a pool of fungible assets such as large scale computing pools, voting systems, and cryptocurrency transactions.

For example, cryptocurrency assets may be mixed using an asset mixing process called coin mixing. For example, Bitcoin coin mixing solutions disguise the links between addresses by pooling the bitcoin input of n users, then outputting the pooled bitcoins to an alternative set of n addresses owned by the users. The CoinJoin implementation of coin mixing simplifies the process by executing the coin mixing process through the use of one single Bitcoin transaction, reducing to 1/n the probability of correctly linking the input of a user with the user's output in the CoinJoin transaction. Mixing services such as CoinShuffle offer solutions to obscure the identity of Bitcoin users via CoinJoin transactions where users send coins to a joined transaction, thereby making it harder to trace the flow of an individual's coins through the blockchain. The process of shuffling the outputs involved in the transaction creates a blur between the inputs and outputs of the transaction. Typically, for a CoinJoin transaction involving n participants (where each participant has one input and one output in the transaction), the probability of correctly linking an input with an output (and therefore correctly guessing the coin flow of a participant) is 1/n.

In one implementation, the system pools unspent cryptocurrency outputs from a plurality of participants and rearranges the order of the output addresses, thereby providing each participant with new outputs from CoinJoin transactions that are more difficult for a 3^{rd} party to track. In an embodiment, a group of participants provides a set of output addresses to the system. The system randomises the order of the output addresses and uses the reordered output addresses to create multiple independent CoinJoin transactions. The transactions are arranged so that each participant has an associated input and output included in two distinctive CoinJoin transactions.

In general, in a single CoinJoin transaction, individual users will have one (or more) input(s) and one (or more) output(s). Additionally, for a Bitcoin transaction, the transaction size is limited to 1 Mbyte, which constrains the total number of inputs and outputs that may be included in a given transaction and therefore limits the number of participants that can be associated with the transaction.

In various illustrative examples described herein, the system builds multiple independent CoinJoin transactions in such a way that a participant to the transaction may have their input and their output included in two different transactions (such as two different transaction records written to a blockchain). The system is able to accomplish this by having a dealer computer system generate an accumulation tree where participants are represented by individual leaf nodes. Locking scripts used by the participants enforce a multi-phase performance of the transaction where if the transaction does not complete successfully after a threshold amount of time, individual participants are able to reclaim any assets contributed to the failed transaction with, or in some examples, without the assistance of the dealer computer system. Each participant deposits an amount of Bitcoin previously agreed upon, and similar to the amount mixed in the CoinJoin transactions, that can be claimed by the said participant when all the independent CoinJoin transactions are included in the public ledger. The protocol has a safety mechanism to ensure that if one of the CoinJoin transactions is not signed by the participants expected to add their input in the said transaction (say a participant within the subgroup allocated to the transaction is malicious), the participants who added an input in and signed one of the other transactions get rightfully compensated. This protocol presents a remarkable feature that is the unlinkability of the CoinJoin transactions, therefore providing for an increase in the number of allowable participants than a single CoinJoin transaction-based solution such as CoinShuffle. This is achieved using quantities derived from a static accumulation tree (local and global digests) built using data provided by the participants to lock and unlock the deposit made by the participants prior to signing and sending the CoinJoin transactions on the network.

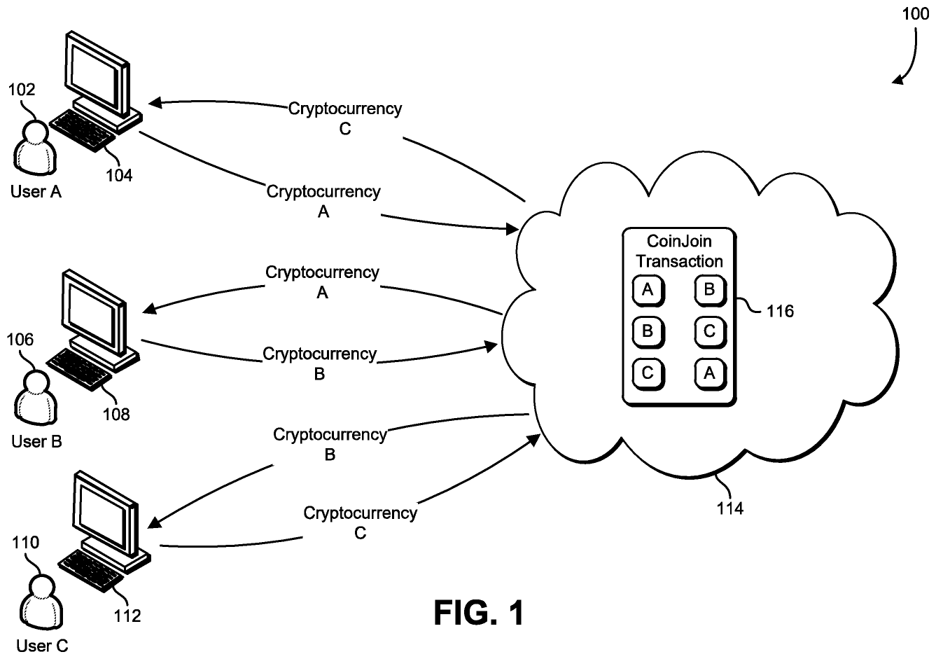

FIG. 1 illustrates an example of a system 100 that performs coin mixing, in an embodiment. Coin mixing is a system where a group of users that want to pool their bitcoins together, and then have their bitcoins distributed to an alternate Bitcoin addresses.

These alternate addresses may or may not be owned by the initial set of users. The system offers protection against an external attacker, because the attacker is generally unable to associate input and output addresses. For example, with n inputs and n outputs, the probability of correctly connecting an input with an output address is approximately 1/n. This is generally true so long as all participants input and output the same amount of cryptocurrency in the mixing pool.

In the embodiment illustrated in FIG. 1, a first user 102 operates a first client computer system 104, a second user 106 operates a second client computer system 108, and a third user 110 operates a client computer system 112. Each client computer system may be a personal computer, laptop computer, handheld device, network-connected appliance, virtual computer system, computer server, point-of-sale terminal, or other computing device. In an embodiment, each computing device hosts a client application made up of instructions stored in memory on the client device. The instructions, as a result of being executed by the client computer system, implement functionality of the client application. The client application interfaces with a blockchain ledger stored in a distributed storage network, such as a Bitcoin ledger or other cryptocurrency blockchain. In some examples, each client computer system interfaces with the blockchain by transmitting and receiving transaction records or a computer network. The computer network may include a wired network such as an ethernet or fiber-optic network, or wireless network such as a Wi-Fi or cellular network.

In an embodiment, each of the three users adds an input and an output to a CoinJoin transaction 116 which is stored on a blockchain 114. Each of the user's inputs and each of the user's outputs have a matching value of cryptocurrency, and the ordering of the outputs is randomly arranged so that an attacker examining the blockchain will not know from which of the users given output was originally obtained.

Some implementations of this solution rely on a coordinating service provider which may exhibit certain undesirable properties:
There is a risk that the coordinating service provider may steal the bitcoins by not forwarding the bitcoins input to the bitcoin addresses provided by the users.
The coordinating service provider may possess knowledge of the linkage between input funds/addresses and output addresses. Should the service provider choose to do so, the service provider could release this information on purpose or by accident.
In general, the coordinating service will impose a fee for utilization of the coin mixing service.

Various embodiments described herein compensate for these and other disadvantages. For example, CoinJoin uses one shared Bitcoin transaction in the transfer of the participants' funds between Bitcoin addresses. Each user adds their bitcoins as an input to the Bitcoin transaction, and each user adds their destination output Bitcoin address to the transaction. By using a single shared transaction, the transaction cost of coin mixing services may be reduced. However, implementations that rely on a coordinating service (such as CoinJoin) may risk the loss of anonymity if the coordinating service is compromised. While in some implementations there is not necessarily a ‘central server’ per se, participants in CoinJoin transactions may nonetheless be able to determine the transaction input which corresponds to the transaction output. For example, assume that the input addresses are {A, B, C, D} and the output addresses are {A′, B′, C′, D′}. If users include their own information in the transaction, input and output addresses may generally be added to the transactions simultaneously. In this situation, the order of the output and input addresses of the transaction may be correlated in the order that they are added to the transaction, making it possible for the participants in the transaction to infer the link between an input address and a corresponding output address. In some implementations, users may “announce” their output address, have it added to a pool by a service, and then have the “order of output addresses” shuffled by the service. However, in such implementations, the announcement of each user's output address may reveal a link between the announcer's input and output address. In order to maintain anonymity, various implementations incorporate the output addresses in the CoinJoin transaction in such a way that the process does not increase the probability of a third party knowing a user's output address beyond 1/n, where n is the number of outputs in the CoinJoin transaction. In an embodiment, a shuffling process produces a set of shuffled output addresses which are later included in a plurality of CoinJoin transactions.

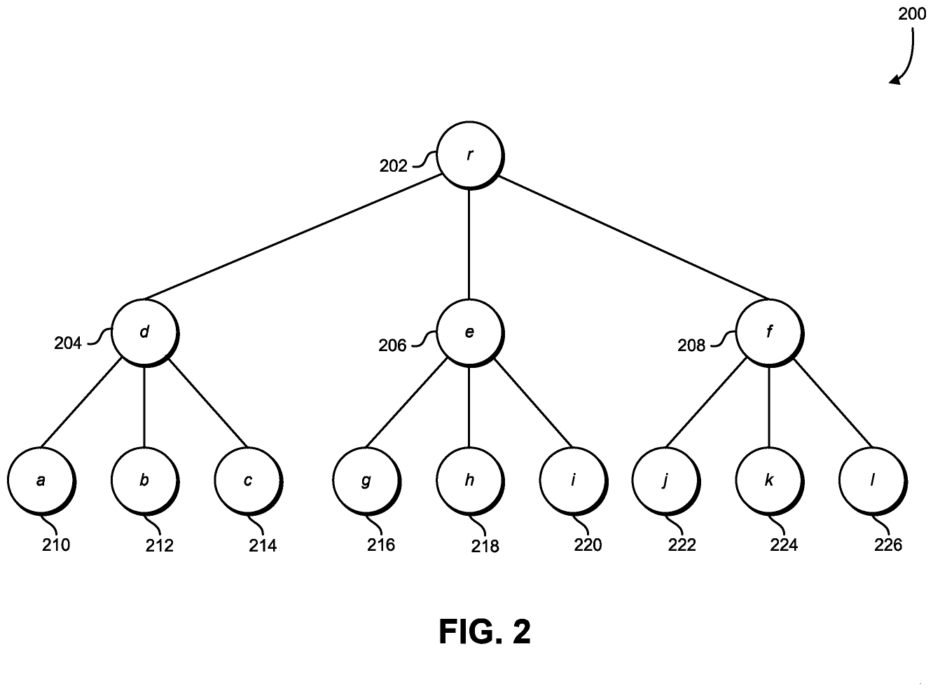

FIG. 2 illustrates an example of an accumulation tree T(ε) 200 for a set of nine elements, in an embodiment. In the example shown, the accumulation tree has nine elements and three levels, and each internal node has three child nodes. In the illustrated example, the accumulation tree has a root node r 202. The root node r 202 has three child nodes: a first intermediate node d 204, a second intermediate node e 206, and a third intermediate node f 208. Each of the three intermediate nodes has three child nodes, each of which are leaf nodes of the accumulation tree. The first intermediate node d 204 has a first child node a 210, a second child node b 212, and a third child node c 214. The second intermediate node e 206 has a first child node g 216, a second child node h 218, and a third child node i 220. The third intermediate node f 208 has a first child node j 222, a second child node k 224, and a third child node l 226.

In various embodiments, cryptographic accumulators may be used to store data in a hash table and perform membership authentication. In some examples, accumulators are RSA-based or bilinear-map accumulators. In various examples, static accumulators (having a fixed set of members) or dynamic accumulators (allowing for the addition or the deletion of members within the set) may be used. A static bilinear-map accumulator may be implemented as follows:

Let G₁, G₂ be two cyclic multiplicative groups of prime order p with generators g₁, g₂. We also assume that there exists an isomorphism Φ: G₂→G₁ such that Φ(g₂)=g₁. Given G_{M}, a cyclic multiplicative group of order p, we can define the bilinear pairing e: G₁×G₂→G_{M} with the following properties:
Bilinearity: e(P^{a}, Q^{b})=e(P, Q)^{ab}∀P∈G₁, Q∈G₂ and a, b∈Zₚ.
Non-degeneracy: (g₁, g₂)≠1.
Computability: there exists an efficient algorithm to compute e(P, Q)∀P∈G₁, Q∈G₂.

In the following example, set G₁=G₂=G and g₁=g₂=g and consider the pairing e: G×G→G_{M}. The bilinear-map accumulator based on the bilinear pairings can accumulate a set of n elements E=(e₁, . . . , eₙ)∈G in the accumulation value ƒ′(E)=g^{(e′}^{₁}^{+s)(e′}^{₂}^{+s) . . . (e′}^{ₙ}^{+s)}. The accumulation value is an element in G and it accumulates element in Z*ₚ. The elements (e′₁, e′₂, . . . , e′ₙ)∈G are a cryptographic hash of the original element of the set E=(e₁, . . . , eₙ)∈G, i.e. e′ᵢ=h(eᵢ) with h: [symbol] → [symbol] *ₚ. h: [symbol] → [symbol] *ₚ is a collision-resistant hash function taking as inputs elements of the multiplicative cyclic group G and producing as outputs integers in [symbol] *ₚ. Finally, s represents the trapdoor information that is kept secret.

To efficiently store the data using authenticated data structures, an accumulation tree is used which generally offers constant time updates and constant size proofs. Use of an accumulation tree generally provides lower communication and verification costs as well as lower storage costs over various alternatives that precompute answers to all possible queries.

In various embodiments, an accumulation tree is used to verify the correctness of the hash values for the subsets involved in the query: the public tree digest for the set confirms the hash values and, in turn, the hash values validate the set.

The accumulation tree is denoted as T(ε) with 0<ε<1. T (ε) represents a rooted tree with n leaves where the n elements of the set E are stored. The number of levels in the tree are defined as

$$l = ⌈ \frac{1}{ɛ} ⌉$$

while the number of children nodes per node is O(n^{ε}). The leaves (or set elements) are at the same level identified with level 0.

For each leaf node νin the tree T(ε) that stores an element e∈[e₁, . . . , e₉], we define the accumulation value ψ(θ) as equal to the value of the element itself:

ψ(ν)=e

For each non-leaf node ν in the tree T(ε) at the levels 1<i<l (here l=2) we define the accumulation as follows:

ψ(ν)=g^{Π}^{_{u∈C(ν)}}^{(h(ψ(u))+s)}

where C(ν) is the set of children of node ν, and (u) is the bilinear local digest of node u. For example, for the accumulation tree in FIG. 1 we have C(ν=d)={a, b, c}. s is the trapdoor of the scheme and h: [symbol] → [symbol] *ₚ is a collision-resistant hash function.

For a given element x belonging to the set E the proof of membership π(x) comprises an ordered sequence of proofs, one per layer of the accumulation tree π(x)={πᵢ, i=1, . . . , l}. Each element of the proof corresponds to the pair composed by a local digest αᵢ and a branch witness βᵢ of the element per level:

πᵢ=(αᵢ, βᵢ), i=1, . . . , l

For a given layer i with 1<i<l we have:

$${α}_{i} = ψ ( {v}_{i - 1} )$$

$${β}_{i} = {g}^{{\prod }_{u ∈ S ( {v}_{i - 1} )} ( h ( ψ ( u ) ) + s )}$$

where S(νᵢ) corresponds to the set of siblings of node νᵢ in the tree T(ε). For example, for the accumulation tree in FIG. 2 the set of siblings is S(ν=d)={e, ƒ}.

For a given layer i, the corresponding proof element includes the following components:
αᵢ that represents the bilinear digest of the node in the previous layer (layer i−1) found in the path of nodes P(x): x→r linking the element x to the root r. For a layer 1<i<l, αᵢ is the same for all the elements present in the layer i−1.
βᵢ that represents the “branch witness”, a witness that authenticates the missing node of the path from the queried node to the root of the tree.

The proof is generally computed by a trusted party and sent to a user/prover. The trapdoor information s is often unknown to the prover. However, the quantities g^{s}, g^{s}^{²} . . . g^{s}^{ⁿ} are made public (generally by the third party).

The global bilinear digest of the whole accumulation tree is:

d=ψ(r)

where

ψ(r)=g^{(h(ψ(d))+s)(h(ψ(e))+s)(h(ψ(ƒ))+s)}

and r indicates the root of the tree.

In a verification phase, the user provides its proof π(x) to a verifier. If g^{s} has been made public the verifier
1. checks that α₁=x;
2. for i=2, . . . , l verifies that e(αᵢ, g)=e(βᵢ₋₁, g^{s+h(α}^{_{i−1}}⁾).

Using the bilinear mapping property, the second relation is equivalent to verifying the following equality:

αᵢ=βᵢ₋₁^{s+h(α}^{_{i−1}}⁾, ∀i=2, . . . , l.

In this example, the proof is accepted if the relations above hold.

In the present document, public/private key pairs are generated using the local and global digests of an accumulation tree built using data provided by the participants. The key pairs are used to lock (and later unlock) deposits made by the participants prior to submission of the CoinJoin transaction for inclusion in the blockchain.

Various embodiments use a key exchange algorithm to establish a shared secret between two parties.

The Diffie-Hellman key exchange protocol is a key-exchange protocol that allows two users to generate a shared secret by exchanging public information. In some embodiments, a key exchange algorithm such as Diffie-Hellman may be used to generate stealth addresses for use with a cryptocurrency. For example, stealth addresses may be used to enhance the anonymity of the Bitcoin protocol. When a stealth address is used, the (potential) recipient of funds publishes a seed value from which an address may be derived. Cryptocurrency is sent to a derived address (rather than the recipient's known public address) and can then be claimed by the intended recipient. Anonymity is provided because it is difficult to derive the address from the seed. In some embodiments, this approach may be constrained if the recipient needs to scan all incoming transaction T×Outs to identify the correct Bitcoin transaction.

A working description of the Diffie-Hellman key exchange protocol is presented here. It is built on top of the generalized discrete logarithm problem on an Elliptic Curve, i.e., the Elliptic Curve Diffie-Hellman key exchange (“ECDH”).

The ECDH protocol involves two users: a sender and a receiver. The sender will use the shared secret to transfer some funds to a derived address that can later be redeemed by the receiver.
The receiver creates a private EC key d and the corresponding public key Q=d×g. This public key is made widely available.
The sender also generates a private key e and its corresponding public key P=e×g.
By exchanging or making publicly available both public keys, the sender and the receiver share a secret defined as c=H(e×Q)=H (d×P) where H is a cryptographic hash function.
Using the shared secret as well as the public key of the receiver, the sender creates a new public key:

Q′=Q+c×g.
Using the homomorphic property of the EC, this new public key can be rearranged as:

Q′=d×g+c×g=(d+c)×g=s×g
where s=d+c is the private key associated to the new generated public key Q′.
A feature of this new public/private key pair is that although both the sender and the receiver can determine only the receiver knows the associated private key s.
In the case of a Stealth Address, the sender does not communicate her public key straight away but instead would send funds to the new public key Q′ and include an OP_RETURN transaction output where the value P would be placed.
The receiver would assume that the data included in each of the OP_RETURN outputs of these transactions is P, and calculate c=H(d×P), the shared secret. If the transaction being considered also has payment to an address generated by the public key Q+(c×g), then the private key for that address is d+c. Only the receiver would have the ability to use the bitcoins at that address as both d and c are known by her, and are not generally known by others.

The present document describes an Accumulators-based Multi-CoinJoin Transaction Submission (“AMCT”) protocol which comprises broadcasting multiple independent CoinJoin transactions on the blockchain such that the link between the input and output addresses owned by the Bitcoin users is obscured. The protocol involves a set of participants, an accumulation tree built to condense information about the participants, and a dealer who will receive information for the participants and use it to construct a secret shared with the participants as well as values derived from the accumulation tree, such as the local and global digests. The participants shuffle their output addresses and the set of shuffled addresses is split into the subsets used to create one or more CoinJoin transactions. The AMCT protocol allows participants to be separated into subgroups that do not intersect with the subset of output addresses. For example, a participant may have her output and input addresses included in two different CoinJoin transactions. Moreover, the CoinJoin transactions may be created in a way that prevents an attacker from easily linking them together. In various examples, the values derived from the accumulation tree are used to lock (and later unlock) a deposit made by the participants before the CoinJoin transactions are broadcast on the blockchain. The dealer may assume the role of safeguard in the case where one or more participants do not sign the CoinJoin transaction associated with their subgroup of participants, by revealing the information needed by the other participants to be compensated.

In an embodiment, a dealer assumes the role of a trusted third party. The participants are a set S of n participants where n can be expressed as the product of two integers: n=N×m. N is the number of subgroups (S₁, . . . , S_{N}) in the set S and m is the number of participants in a given subgroup. Each subgroup of participants Sᵢ is responsible for broadcasting one CoinJoin transaction T_{C}ⁱ on the Bitcoin blockchain.

Each participant has one input and one output that is to be included in one of these CoinJoin transactions. The participant is not generally the recipient of the funds in the output address, i.e., the participant is not trying to move funds from one of its addresses to a new one which it owns the private keys of. In this case, the funds can be unlocked with the signature of the recipient.

Each CoinJoin transaction includes m inputs and m outputs, each of those spending (unlocking) or receiving x Bitcoin (BTC). An accumulation tree T(ε) is built by the dealer that stores the elements (e₁, . . . , eₙ) provided by the n participants.

The structure of the accumulation tree reflects the distribution of participants in subgroups among the set S, i.e m is the number of leaves per node in the bottom layer of the accumulation tree and N is the number of nodes in the penultimate layer (the N parent nodes each have of m leaves).

The output addresses of the participants are shuffled and the final set of shuffled output addresses is split into N subsets of m output addresses. The dealer creates a CoinJoin transaction for each subset of output addresses. The dealer then sends the CoinJoin transaction T_{C}ⁱ to the subgroup of participants Sᵢ for the addition of their respective inputs and signatures. In various examples, a participant may have its input and its output included in a different CoinJoin transaction. In additional examples, the dealer may split a single large transaction into a plurality of smaller ones to overcome a limitation on the size of a transaction.

Before the submission of the CoinJoin transactions for inclusion in the blockchain, each participant commits a deposit of y BTC. The deposit is sent to a P2SH address and can be unlocked in two distinctive ways:
Using quantities derived from the accumulation tree if all the CoinJoin transactions are successfully included in the blockchain before a given point in time ΔT.
Using quantities revealed by the dealer if all the CoinJoin transactions are not successfully included in the blockchain after a given point in time ΔT.

Although the N CoinJoin transactions should be submitted independently and quasi-simultaneously, it is possible that a participant does not add its input in the CoinJoin transaction assigned to its subgroup and therefore leaves the said transaction incomplete/invalid. As a result, the participants in the subgroup will not unlock their input. In the meantime, participants in the other subgroups who signed and submitted their CoinJoin transaction for inclusion in the blockchain have spent their input and risk not having received coins in their output address if the latter was included in the transaction that was not broadcast on the blockchain. It may be difficult or impossible to force a participant to fulfil its role, i.e., add and sign its input in the CoinJoin transaction. Therefore, in some embodiments, we provide a mechanism that compensates participants who would have spent their input and did not receive coins due to the misbehaviour of another participant. Participants that are not successful in having their CoinJoin transaction included in the blockchain may not necessarily be malicious. For example, a participant could involuntarily lose connection during the protocol. Also note that even one participant dropping the protocol for one CoinJoin transaction with m inputs/outputs may cause the transaction to fail. Therefore, the participants belonging to the same subgroup as that of the malicious participant should not be penalised for the misbehaviour of another participant, nor should they benefit from it.

The AMCT protocol is described in detail below. We discuss the construction of the Accumulation Tree and the exchange of information between the participants and the dealer. Then we describe the process of shuffling the output addresses. We then discuss the creation and submission of the participants' deposit transactions. The next sections explain the creation and submission of the CoinJoin transactions and the return/compensation claim after the submission of all or some of the CoinJoin transactions.

Throughout this document, embodiments are described with reference to a sample case involving four participants split into two subgroups of two participants. We assume a random order of participants (or sequence), U₁, U₂, . . . , Uₙ where n=N×m, N is the number of subgroups in the set and m is the number of participants in a given subgroup. In our example, n=4, N=m=2.

Each participant Uᵢ chooses a random point on the Elliptic Curve eᵢ and communicates the hash of it, e′ᵢ=h(eᵢ), to the dealer. h: [symbol] → [symbol] *ₚ is a collision-resistant hash function. The dealer chooses a secret s (trapdoor information) and reconstructs the global digest of the accumulation tree as follows:

d=ψ(r)=g^{(e′}^{₁}^{+s)(e′}^{₂}^{+s) . . . (e′}^{ₙ}^{+s)}

The trapdoor information s is unknown to the participants. However, the quantities g^{s}, g^{s}^{²} . . . g^{s}^{ⁿ} are made public.

The dealer computes the local digests, ψ(ν₁), . . . , ψ(ν_{N}) where νᵢ, i∈[1, N] is one of the parent nodes in the penultimate layer of the accumulation tree. Neither the local nor global digests are communicated to the participants.

The dealer uses the digest d as a private key. In an embodiment, since the global digest is a point of the Elliptic Curve, the dealer chooses a number ν derived from it. For instance ν can be one coordinate (x_{d} or y_{d}) of d, or the concatenation (sum) of the two, or even a number resulting from the hashing of the global digest where the hashing function is a function (known to the participants) taking a point from the Elliptic Curve as input and outputting a number in the [symbol] *ₚ field.

The dealer uses the x coordinate for the point in the Elliptic Curve corresponding to the global digest of the accumulation tree. We thus define ν=x_{d} as the private key and Q as the associated public key: Q=ν×g (g is the generator of the Elliptic Curve).

The dealer makes Q available to the participants.

Each participant Uᵢ chooses a random private key yᵢ and publishes the corresponding public key: Pᵢ=yᵢ×g.

The participants also choose random numbers (salt) in the [symbol] *ₚ field that they communicate privately to the dealer (for example, the participants may send their random number to the dealer using an encryption key made public by the dealer, whose associated decryption key is only known by the dealer). We denote ωᵢ as the salt chosen by the participant Uᵢ, which can be seen as a private key. Both the dealer and the participant Uᵢ can deduce the associated public key Wᵢωᵢ×g. This public key is not made public.

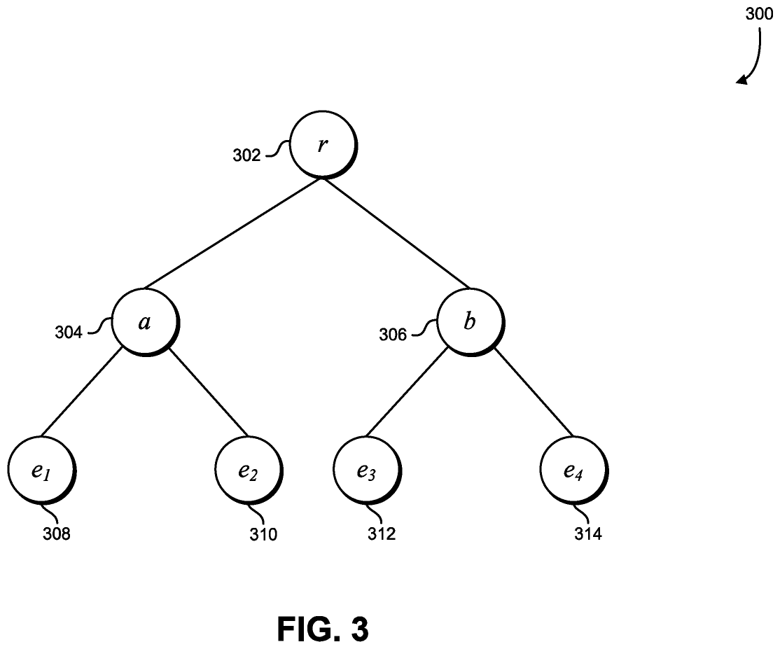

In the present document, we illustrate various embodiments with a simple example, involving n=4 participants split into two subgroups (N=2) of two participants (m=2), as illustrated in FIG. 3.

FIG. 3 illustrates an example of an accumulation tree where each leaf node has an associated element eᵢ for i=1 . . . 4, in an embodiment. In the example shown, the accumulation tree has four elements and three levels, and each internal node has two child nodes. In the illustrated example, the accumulation tree has a root node r 302. The root node r 302 has two child nodes: a first intermediate node a 304, and a second intermediate node b 306. Each of the two intermediate nodes has two child nodes, each of which are leaf nodes of the accumulation tree. The first intermediate node a 304 has a first child node e₁ 308 and a second child node e₂ 310. The second intermediate node b 306 has a first child node e₃ 312, and a second child node e₄ 314.

The first two participants (U₁, U₂) share the local digest ψ(a) while the second subgroup of participants (U₃, U₄) shares the local digest ψ(b). The global digest in this example is given by the following relation: d=ψ(r)=g^{(h(ψ(a))+s)(h(ψ(b))+s)}.

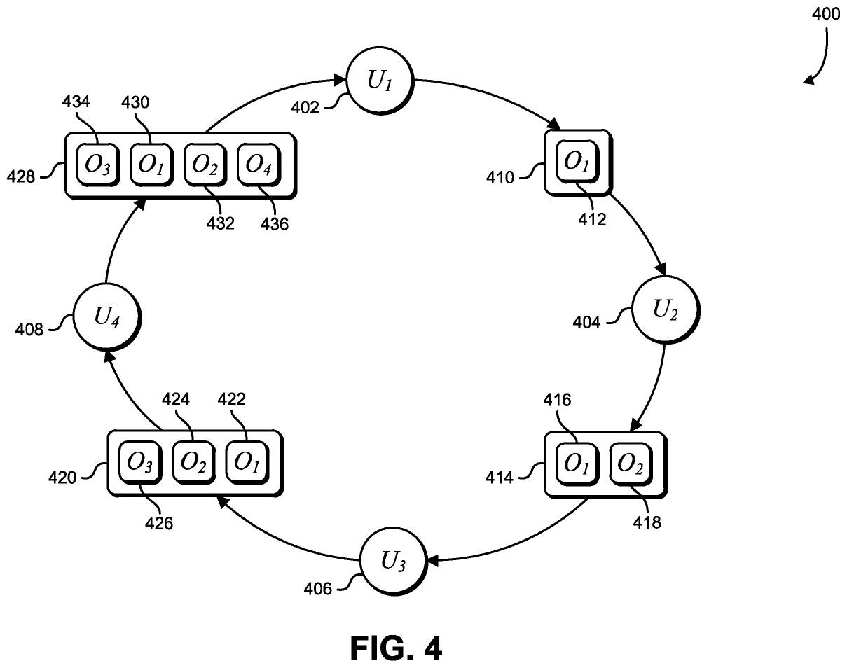

FIG. 4 illustrates an example of output shuffling performed as part of a multi-CoinJoin transaction, in an embodiment. In an embodiment, the process of shuffling the set of output addresses given by the participants includes two phases; an encryption phase and a decryption phase.

In the encryption phase, each participant Uᵢ has a corresponding public/private key pair: (Eᵢ, kᵢ) where Eᵢ=kᵢ×g (g is the generator of the Elliptic Curve chosen by the protocol). The public keys E₁, E₂, . . . , Eₙ are sent to the dealer which makes them available to the other participants in such way that the order of participants, U₁, U₂, . . . , Uₙ is known to them. For example, the dealer may make the public keys available in the form of an ordered list or array.

In the encryption phase, the first participant, U₁, encrypts the first participant's output address O₁ with the first participant's public key E₁. The resulting encrypted output address comprises the “set of shuffled outputs” (SSO).

U₁ encrypts the SSO with E₂, the public key of the next participant, U₂, and forwards the encrypted SSO to U₂. U₂ then decrypts the SSO using k₂, encrypts U₂'s output address O₂ using E₂, and adds this newly encrypted address to the SSO. U₂ shuffles the order of the encrypted addresses within the SSO, encrypts the shuffled SSO with E₃, and then forwards the encrypted SSO to the third participant U₃. This process continues until it reaches Uₙ, where n is the total number of participants in the protocol. In our illustration, we chose n=4 to keep the example simple, but in general much larger values of n are preferred. After the encrypted output address of the last participant is added to the SSO, Uₙ performs a final shuffle, encrypts the SSO with E₁, and sends the SSO back to the first participant, U₁.

In the example illustrated in FIG. 4, a first participant 402 encrypts the first participant's output address 412, and adds the address to a first set of shuffled outputs 410. The first participant 402 encrypts the first set of shuffled outputs 410 using the public key of a second participant 404, and provides the encrypted first set of shuffled outputs to the second participant 404.

The second participant 404 encrypts the second participant's output address 418, and adds the address to a second set of shuffled outputs 414 that includes the first participant's output address 416. The second participant 404 encrypts the second set of shuffled outputs 414 using the public key of a third participant 406, and provides the encrypted second set of shuffled outputs to the third participant 406.

The third participant 406 encrypts the third participant's output address 426, and adds the address to a third set of shuffled outputs 420 that includes the first participant's output address 422 and the second participant's output address 424. The third participant 406 encrypts the third set of shuffled outputs 420 using the public key of a fourth participant 408, and provides the encrypted third set of shuffled outputs to the fourth participant 408.

The fourth participant 408 encrypts the fourth participant's output address 436, and adds the address to a fourth set of shuffled outputs 428 that includes the first participant's output address 430, the second participant's output address 432, and the third participant's output address 434. The fourth participant 408 encrypts the fourth set of shuffled outputs 428 using the public key of the first participant 402, and provides the encrypted fourth set of shuffled outputs to the first participant 402.

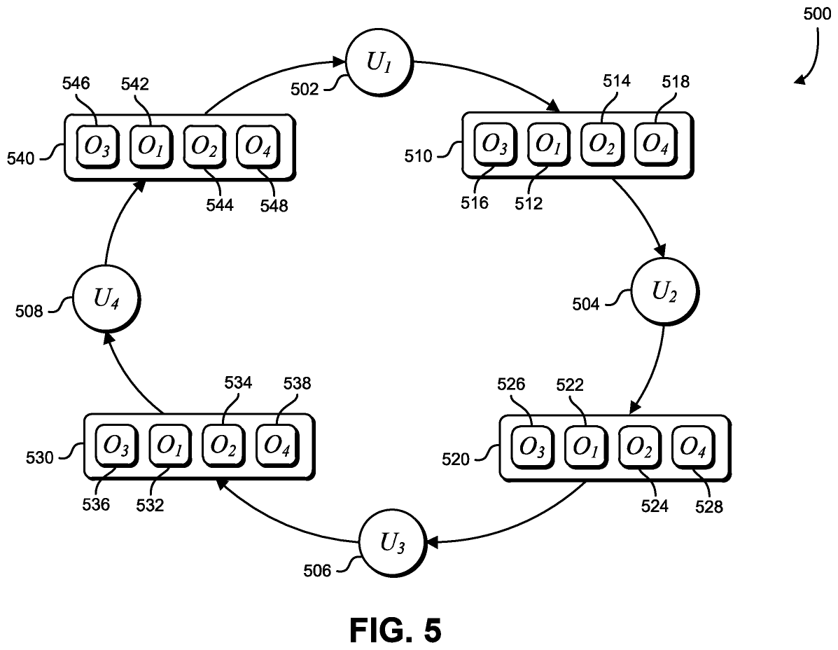

FIG. 5 illustrates an example of a decryption operation performed as part of a multi-CoinJoin transaction, in an embodiment. In an embodiment, as part of the decryption phase, the SSO is routed to each of the n original participants. At the end of the first encryption-shuffle loop, a first participant U₁ 502 is in possession of a first set of shuffled outputs 540. The first set of shuffled outputs 540 includes a first encrypted output address 542, a second encrypted output address 544, the third encrypted output address 546, and a fourth encrypted open address 548. U₁ 502 decrypts the SSO, searches for the first participant's encrypted output address 542 in the SSO, and decrypts the address using the associated private key k₁.

At that point, the first participant learns the new position of its output addresses in the SSO. During the decryption phase, the participants check the position of their output address so they know later which subgroup is responsible for broadcasting the CoinJoin transaction including it. However, a participant remains unaware of the position of the other participants' outputs.

For that purpose the dealer creates an ephemeral public/private key pair: (E_{D}, k_{D}) and makes the public key available to the participants. The participants will use E_{D} to encrypt their output address in the shuffled SSO (represented in FIG. 5 as address 512 of set 510, addresses 522, 524 of set 520, addresses 532, 534, 536 of set 530, and addresses 542, 544, 546 and 548 of set 540).

As the decryption phase proceeds, the first participant decrypts its output address using the associated private key k₁ and re-encrypts O₁ with E_{D}. U₁, then encrypts the new SSO with the public key P₂ of the second participant, and forwards a second encrypted set 510 to U₂ 504. The second encrypted set 510 includes a first encrypted output address 512, a second encrypted output address 514, a third encrypted output address 516, and a fourth encrypted open address 518. The second participant decrypts the SSO using k₂, finds the second participant's output address 514, decrypts it using k₂, and re-encrypts it with E_{D}. U₂ 504 then encrypts the new SSO with the public key P₃ and forwards a third encrypted set 520 to U₃ 506. The third encrypted set 520 includes a first encrypted output address 522, a second encrypted output address 524, a third encrypted output address 526, and a fourth encrypted open address 528. The third participant decrypts the SSO using k₃, finds the third participant's output address 514, decrypts it using k₃, and re-encrypts it with E_{D}. U₃ 506 then encrypts the new SSO with the public key P₄ and forwards a fourth encrypted set 530 to U₄ 508. The fourth encrypted set 530 includes a first encrypted output address 532, a second encrypted output address 534, a third encrypted output address 536, and a fourth encrypted open address 538. In various examples, the process continues until each participant has found its encrypted output address in the SSO and replaced it with its corresponding decrypted (and encrypted with E_{D}) value.

The last participant 508 encrypts the SSO with E_{D} (instead of encrypting it using E₁) and sends the encrypted SSO to the dealer. The dealer is then in possession of a set of encrypted outputs. Only the dealer knows the private key k_{D} and therefore can decrypt the set and each output address in it.

The permutation of the output addresses in the SSO at that point represents the final order in which the outputs are included in the CoinJoin transactions.

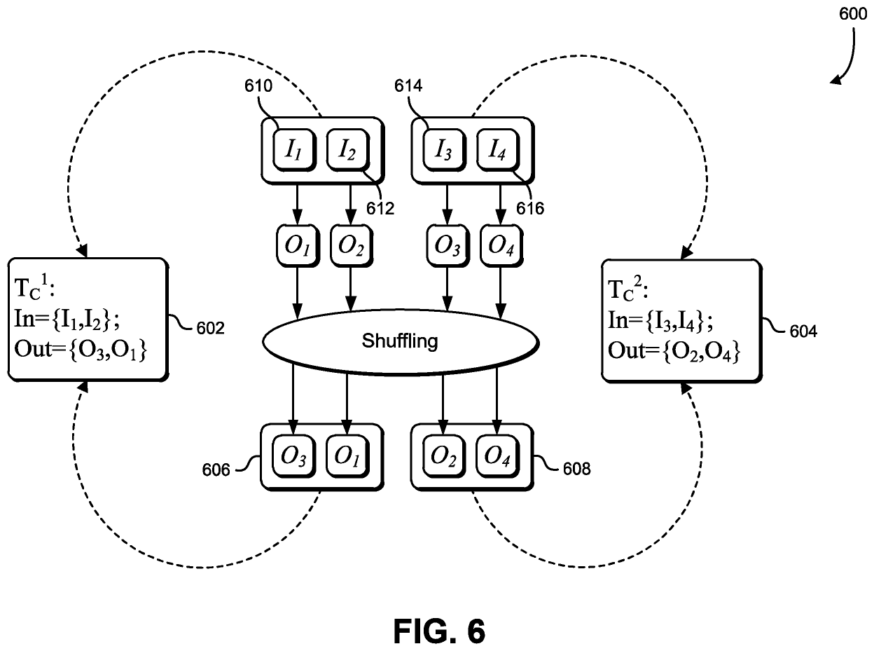

FIG. 6 illustrates an example of a reordering of output addresses performed as part of a multi-CoinJoin transaction, in an embodiment. After the output addresses are shuffled as described above, each participant knows their initial position in the sequence and the final position of their output addresses. FIG. 5 illustrates a possible final order of the output addresses in our example with 4 participants. In this example, the third participant U₃ knows that its output address is the first element in the SSO. As a result, U₃ knows that its output address will be included in the first CoinJoin transaction.

In this example, we consider a set of 4 participants, split into two subgroups of two participants each. Therefore, the dealer is expected to create two CoinJoin transactions, namely T_{C}¹ 602 and T_{C}² 604 as illustrated in FIG. 6:
The first transaction T_{C}¹ 602 will include the output addresses of the third and first participants 606 (U₃ and U₁ respectively).
The second transaction T_{C}² will include the output addresses of the second and fourth participants 608 (U₂ and U₄ respectively).

The dealer will create these two CoinJoin transactions and send them incomplete to the participants who will add their input, sign transactions and submit them for inclusion in the blockchain. Before the dealer sends the said transactions to the participants, each participant will create and broadcast a transaction in which they unlock some coins that can be reclaimed later if the protocol ends with the successful broadcast of all the CoinJoin transactions. In an embodiment, a first participant commits a first input 610, a second participant commits a second input 612, a third participant commits a third input 614, and a forth participant commits a fourth input 616. In case the protocol ends prematurely (not all CoinJoin transactions are broadcast), a compensation mechanism is considered.

In an embodiment, the protocol assures that the transactions involved in the protocol are unlinkable. This means that an attacker is not be able to easily link the CoinJoin transactions sent to the network. In addition, no link is established between the deposit transactions and the CoinJoin transactions. Therefore, P2SH addresses are generated as described below, using a shared secret between the dealer and the participants, as well as quantities derived from the accumulation tree.

Using the information made publicly available and the Diffie-Hellman key exchange protocol, the dealer composes a secret cᵢ for each participant Uᵢ, and shares with the said participant:

cᵢ=H(ν×Pᵢ)=H(Q×yᵢ)

where H is a hash function (known to the participants) taking a point from the Elliptic Curve as input and outputting a number in the [symbol] *ₚ field.

The participant uses this shared secret to create a new public key:

Bᵢ=Pᵢ+Q+cᵢ×g

Bᵢ=sᵢ×g where sᵢ=yᵢ+ν+cᵢ

sᵢ is the private key associated to Bᵢ. Although Pᵢ and Q are publicly known, in general, only the dealer and the participant Uᵢ know the shared secret cᵢ. As a result, only the dealer and the participant Uᵢ know the public key Bᵢ while no one (participant or dealer) knows the associated private key sᵢ (ν is only known by the dealer and yᵢ is kept private by the participant Uᵢ. The dealer can verify the validity of a Bitcoin address generated by Uᵢ using the public key Bᵢ. To unlock the fund sent to this address, the participant Uᵢ needs to compute ν (i.e., the global digest of the accumulation tree) in order to reconstruct the private key sᵢ. This also protects the participant against a malicious dealer who would attempt to steal the participant's fund.

Each participant Uᵢ chooses and communicates a random number to the dealer, Knowing the initial and final order of the output addresses in the SSO, the participant creates the following public key:

C_{i→j}=Wᵢ+Pⱼ=c_{i→j}×g where c_{i→j}=ωᵢ+yⱼ

where i corresponds to the initial index of an output address (the actual position of the participant Uᵢ in the sequence) and j corresponds to index of the output after shuffling. Pⱼ is the public key made available by the participant Uⱼ. Although both the dealer and the participant Uᵢ know the public keys θᵢ and Pⱼ, which allows the dealer to verify the validity of any address derived from the public key C_{i→j}, neither of them know the associated private key c_{i→j}. Actually at that point of the protocol, no one (participant or dealer) knows the secret c_{i→j}. The first part (ωᵢ) is known by the dealer and the participant Uᵢ while the second part (yᵢ) is known only by the participant Uⱼ. If the dealer was to make ωᵢ public, then and only then participant Uⱼ could compute the secret c_{i→j} and unlock funds sent to an address derived from C_{i→j}.

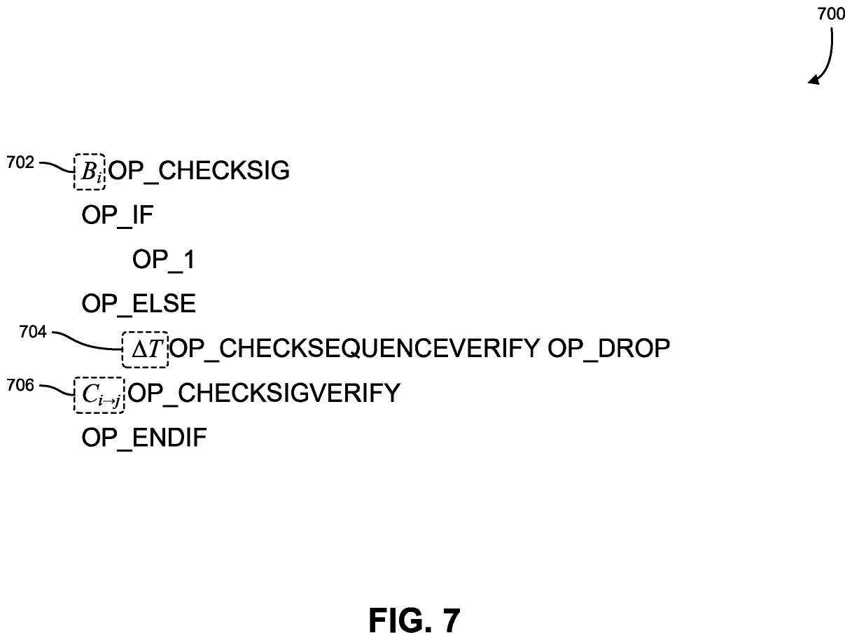

FIG. 7 illustrates an example of a locking Script 700 generated by a participant for a deposit as part of a multi-CoinJoin transaction, in an embodiment.

Two new public keys, Bᵢ 702 and C_{i→j} 706, are created per participant Uᵢ whose validity is verified by the dealer:
Bᵢ=sᵢ×g where sᵢ=yᵢ+cᵢ. Only the participant Uᵢ knows the private key sᵢ.
C_{i→j}=c_{i→j}×g where c_{i→j}=ωᵢ+yⱼ. Both the dealer and the participant Uᵢ know the public key C_{i→j}. Note the the participant Uⱼ does not know the public key C_{i→j}. However, if (at some point in time) the dealer were to make ωᵢ public, then participant Uⱼ (only) could compute the secret c_{i→j}.

Using these two public keys, the participant Uᵢ creates the following locking script 700 as shown in FIG. 7. The script is used to lock the deposit of y BTC made by each participant before the completion and submission of the CoinJoin transactions for inclusion in the blockchain.

The locking time parameter is defined using the opcode OP_CHECKSEQUENCEVERIFY. This new opcode for the Bitcoin scripting system (OP_CHECKSEQUENCEVERIFY) was introduced in B1P112; it allows execution pathways of a script to be restricted based on the age of the output being spent.

ΔT 704 corresponds to a period of time after confirmation of the transaction on the blockchain during which the output cannot be spent (any transaction trying to unlock this UTXOs will not be mined until a certain timespan or an age of the spent output in the blocks).

The Script 700 offers two options to unlock the UTXO of the deposit transaction Dₓⁱ broadcast by the participant Uᵢ: at any time by providing the signature associated to the secret sᵢ or after ΔT 704 by providing the signature associated to the secret c_{i→j} 706.

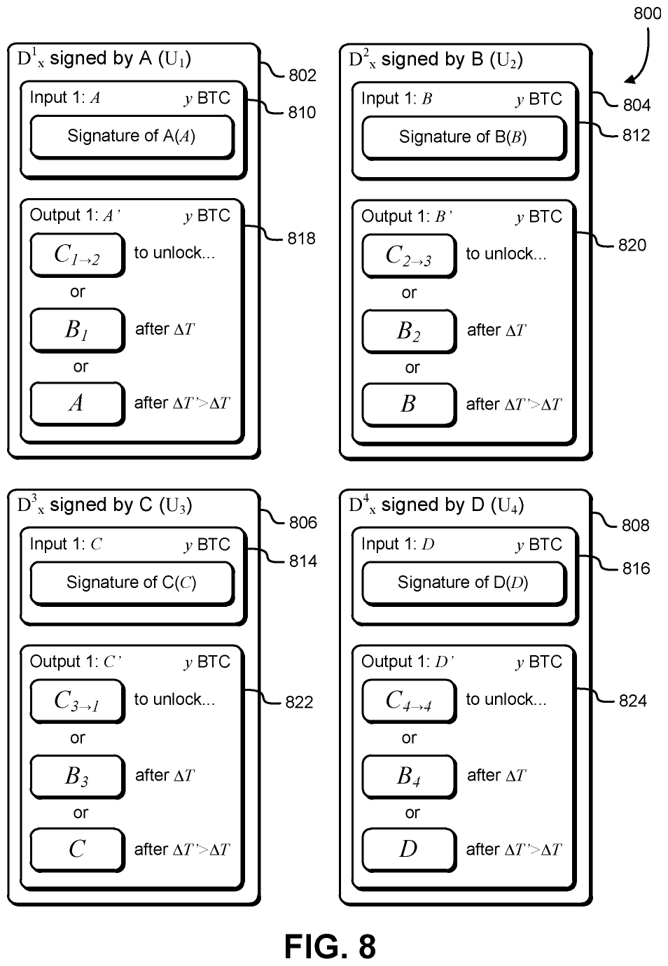

FIG. 8 illustrates an example of deposit transactions 800 created, signed and broadcast by four participants in a multi-CoinJoin transaction, in an embodiment. The deposit transactions 800 are submitted for inclusion in the blockchain. Once included in the blockchain, the dealer can forward the partial CoinJoin transactions to the participants for inclusion of their input and signature before broadcast.

An embodiment illustrated in FIG. 8 shows a first deposit transaction 802, a second deposit transaction 804, a third deposit transaction 806, and a fourth deposit transaction 808. Each deposit transaction is submitted by a corresponding participant. The first deposit transaction 802 includes a first input 810 committing y BTC. The second deposit transaction 804 includes a second input 812 committing y BTC. The third deposit transaction 806 includes a third input 814 committing y BTC. The fourth deposit transaction 808 includes a fourth input 816 committing y BTC.

In an embodiment, each deposit transaction includes an output that pays the y BTC to one of three conditions. The first deposit transaction 802 includes a first output script 818. The second deposit transaction 804 includes a second output script 820. The third deposit transaction 806 includes a third output script 822. The fourth deposit transaction 808 includes a fourth output script 824. In the embodiment shown in FIG. 8, the output of each deposit transaction may be claimed in three ways: the output may be claimed by a particular participant as part of a successful CoinJoin transaction, the output may be claimed by the depositor after a particular amount of time ΔT, or the output may be claimed by the depositor after a second amount of time which is greater than ΔT.

In the embodiment shown in FIG. 8, the third option to unlock the UTXOs in the deposit transactions is included, and this option is available after a timespan ΔT′>ΔT. The third option is a safeguard allowing the participants to redeem their funds after a certain point in time if the protocol ends prematurely (for example, to provide a protection against the dealer). In this third option, a participant provides its signature for the funds to be unlocked (after ΔT′). The script in FIG. 7 can be modified to include this third option.

Once included in the blockchain, the dealer forwards the partial CoinJoin transactions to the participants.

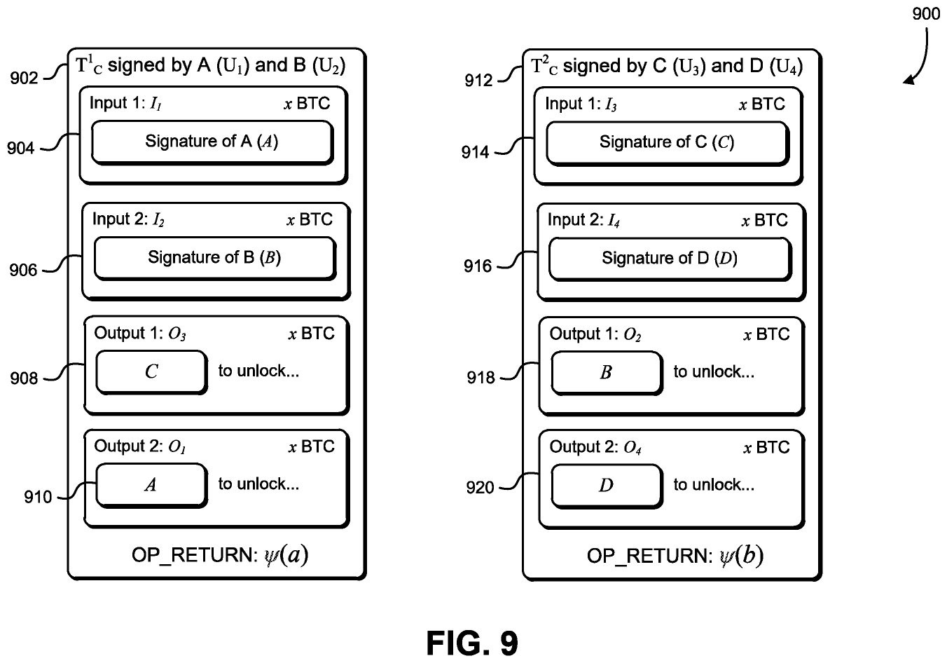

FIG. 9 illustrates an example of a transaction two CoinJoin transactions created and signed by participants in a multi-CoinJoin transaction, in an embodiment.

The dealer creates the CoinJoin transactions, T_{C}¹ 902 and T_{C}² 912 in our example, including the output addresses given in the SSO, and including an extra piece of information in the transactions using the OP_RETURN operator. The first CoinJoin transaction includes a first input 904, a second input 906, a first output 908, and a second output 910. The second CoinJoin transaction includes a first input 914, a second input 916, a first output 918, and a second output 920.

Knowing the hashes of all the elements in the accumulation tree and the trapdoor information s, the dealer computes the local digests of the accumulation tree (ψ(a) and ψ(b) in FIG. 3). The dealer adds the local digest of a subgroup of participants as an extra provably unlockable output in the CoinJoin transaction that the participants in the subgroup need to complete before broadcast.

The dealer then sends each incomplete CoinJoin transaction to the first participant in each subgroup: T_{C}¹ is sent to U₁ and T_{C}² is sent to U₃ in our example. The participants in a given subgroup may collaborate and exchange the hashes of their individual element so they can compute their common local digest and verify the data put in the OP_RETURN script by the dealer.

The first participant in a subgroup adds their input and signs the transaction using the flag SIGHASH_ALL|ANYONECANPAY. It then forwards the partially signed transaction to the next participant. This continues until the last participant in a subgroup adds and signs the CoinJoin transaction and broadcasts the completed CoinJoin transaction on the blockchain.

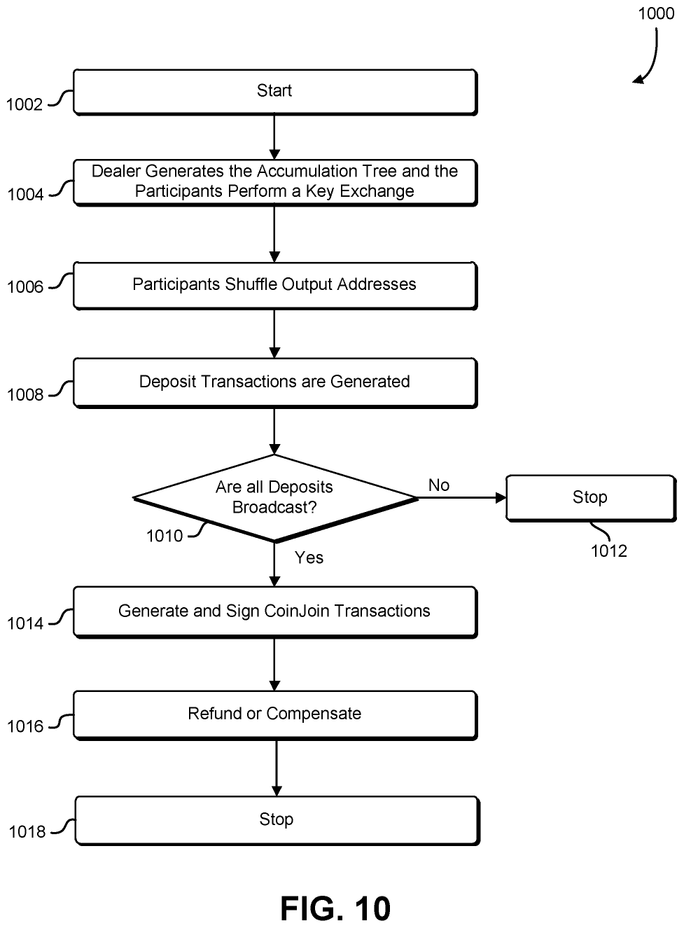

FIG. 10 illustrates an example of a process that, as a result of being performed by a dealer computer system and one or more participant computer systems, performs a multi-CoinJoin transaction, in an embodiment. A flowchart illustrates a process 1000 that begins at block 1002. At block 1004, the dealer generates an accumulation tree for generating the CoinJoin transactions, and the participants perform a key exchange with the dealer. At block 1006, the participants shuffle their output addresses to determine a final ordering and grouping for the CoinJoin transactions. At block 1008, each participant generates a deposit transaction committing a number of BTC.

At decision block 1010, the dealer determines whether all of the participants have committed their deposits to the blockchain. If not all of the participants have committed their deposits to the blockchain, execution stops at block 1012, and the CoinJoin process is aborted. If the dealer determines that all the participants have committed their deposits to the blockchain, execution advances to block 1014 where the dealer generates the CoinJoin transactions, and the CoinJoin transactions are routed amongst the participants to obtain the necessary signatures. At block 1016, the dealer determines whether the transactions were successfully signed and committed to the blockchain, and if there was a problem with some or all of the transactions, the dealer performs operations that return or compensate appropriate participants of the field transactions.

In an embodiment, a point in time T₁ is negotiated between the dealer and the participants such that all the CoinJoin transactions should be included in the blockchain before that point in time has been reached. When the time is reached, either all N CoinJoin transactions will be included in the blockchain, or not.

CASE 1: all N CoinJoin transactions are included in the blockchain before T_{I}.

The CoinJoin transactions are all included in the blockchain before T_{I} and the participants collect the data in each OP_RETURN script. The participants can then compute the global digest d of the accumulation tree. Indeed, in our example where only two CoinJoin transactions are broadcast, the global digest can be expressed as a function of the local digests, as follows:

d=ψ(r)=g^{(h(ψ(a))+s)(h(ψ(b))+s)}

Recall that the quantities g^{s}, g^{s}^{²} . . . g^{s}^{ⁿ} are made public.

The participant Uᵢ can now compute sᵢ=ν+yᵢ where ν is derived from the global digest, and the participant Uᵢ can unlock the funds sent in the deposit transaction Dₓⁱ it broadcast earlier.

CASE 2: not all N CoinJoin transactions are included in the blockchain before T_{I}.

If for any reason a participant does not add its input and sign the CoinJoin transaction associated to its subgroup, the said transaction will never be included in the blockchain.

As a result, the participants will not be able to reconstruct the global digest of the accumulation tree and therefore will not be able to unlock the funds spent in their deposit as in CASE 1.

In this case, the participants fall in four categories:

Category 1: the ones who spent their input (the CoinJoin transaction they signed is included in the blockchain) and received coins at their output address (their output address is included in one of the CoinJoin transactions included in the blockchain). These participants have a balance of −y BTC after the broadcast of some or all of the CoinJoin transactions.

Category 2: the ones who spent their input but did not receive coins to their output address. These participants have a balance of −x −y BTC after the broadcast of only some of the CoinJoin transactions.

Category 3: the ones who did not unlock their input (the transaction they signed or did not sign was not sent or was not valid and therefore not included in the blockchain) but receive coins to their output address. These participants have a balance of x−y BTC after the broadcast of only some of the CoinJoin transactions.

Category 4: the ones who did not unlock their input and did not receive coins to their output address. These participants have a balance of −y BTC after the broadcast of some or none of the CoinJoin transactions.

CASE 1 corresponds to the scenario where all participants are of Category 1.

The dealer has a time window [T_{I},ΔT] to help the participants to reclaim their deposit and potentially be compensated if they fall in Category 2.

The dealer reveals the set of ωᵢ values of the participants whose output address are embodied in the CoinJoin transactions successfully included in the blockchain. This allows those participants that added their input and signed the CoinJoin transactions, and which may fall into Category 2 or 4, to be rightfully compensated.

The remaining participants can then, at a point in time t>ΔT, redeem the funds sent in their deposit transaction if these remain unspent by another participant during the compensation phase.

The dealer should reveal the subset of ωᵢ values before the time ΔT has elapsed. Indeed, if all but one CoinJoin transaction are included in the blockchain, some or all the participants in the malicious subgroup who did not broadcast their assigned CoinJoin transaction may know all the local digests and therefore be able to reconstruct the global digest needed to unlock the funds spent in each participant's deposit transaction. One could then imagine a scenario where a malicious participant does not add its input to the CoinJoin transaction assigned to its group but receives coins at its output address included in another CoinJoin transaction (Category 3). After ΔT and unless the UTXO sent in its deposit transaction are already claimed, the participant knowing its local digest could reconstruct the global digest and collect the said UTXO.

For instance, we consider the case where the third participant does not sign T_{C}² in our example based on four participants.

At a point in time Tₗ<t<ΔT, the four participants' balance is as follows:

| | CoinJoin | Deposit | Total |
|---|---|---|---|
| Participants | balance | Balance | Balance |
| A (U₁) | 0 | −y | −y |
| B (U₂) | −x | −y | −(x + y) |
| C (U₃) | +x | −y | x − y ~ 0 |
| D (U₄) | 0 | −y | −y |

The dealer then reveals the set of value {ω₃, ω₁}. This allows the first participant to compute the quantity c_{3→1}=y₁+ω₃ while the second participant computes c_{1→2}=y₂+w₁. The first participant can therefore unlock the UTXO in Dₓ³ while the second participant can unlock the UTXO in D.

At a point in time ΔT<t<ΔT′, the four participants' balance has changed as follows:

| | CoinJoin | Deposit | Total |
|---|---|---|---|
| Participants | balance | Balance | Balance |
| A(U₁) | +y | −y | 0 |
| B (U₂) | −x + y | −y | −x |
| C (U₃) | +x | −y | x − y ~ 0 |
| D (U₄) | 0 | −y | −y |

After ΔT′ has elapsed, the UTXOs in the two remaining deposit transactions, Dₓ² and Dₓ⁴, can be spent by their original creators. The second and fourth participants reclaim their deposit.

At that point in time t>ΔT′, the four participants' balance is restored as follows:

| | CoinJoin | Deposit | Total |
|---|---|---|---|
| Participants | balance | Balance | Balance |
| A (U₁) | +y | −y | 0 |
| B (U₂) | −x + y | 0 | y − x ~ 0 |
| C (U₃) | +x | −y | x − y ~ 0 |
| D (U₄) | 0 | 0 | 0 |

The amount of Bitcoin spent per deposit transaction, say y BTC, should be very close to the amount x BTC mixed in the CoinJoin transactions, so that the total balance for each participant is close to zero whether the CoinJoin transactions are all broadcast or not. There might be a small difference that arises from the different fees for the miner included in the CoinJoin and deposit transactions.

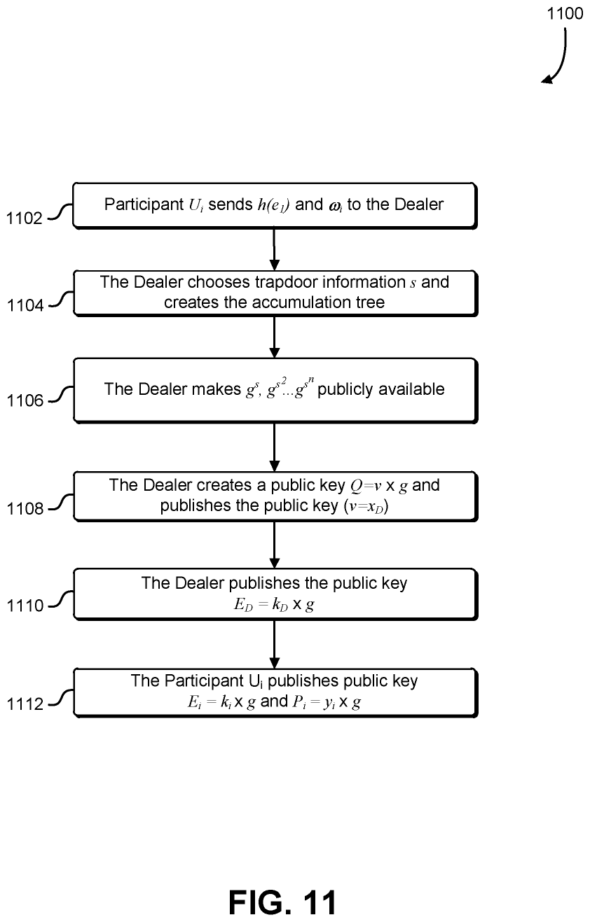

FIG. 11 illustrates an example of a process that, as a result of being performed by a dealer computer system and one or more participant computer systems, performs a key exchange and builds an accumulator tree for use in a multi-CoinJoin transaction, in an embodiment. A flowchart illustrates a process 1100 that begins at block 1102 with each participant computer system U, generating an element eᵢ and sending a hash of the element h(eᵢ) and a salt ωᵢ to the dealer. At block 1104, the dealer chooses trapdoor information s and creates the accumulation tree. At block 1106, the trapdoor information s is kept secret by the dealer, but the dealer publishes g^{s}, g^{s}^{²}, g^{s}^{ⁿ}, where the values are points on the Elliptic Curve derived from the trapdoor information s, and where n is the number of participants or number of leaves in the tree. At block 1108, the dealer creates a public key Q=v×g and publishes the public key (v=x_{D}). At block 1110, the dealer publishes the public key E_{D}=k_{D}×g. At block 1112, each participant U, publishes their public key Eᵢ=kᵢ×g and Pᵢ=yᵢ×g.

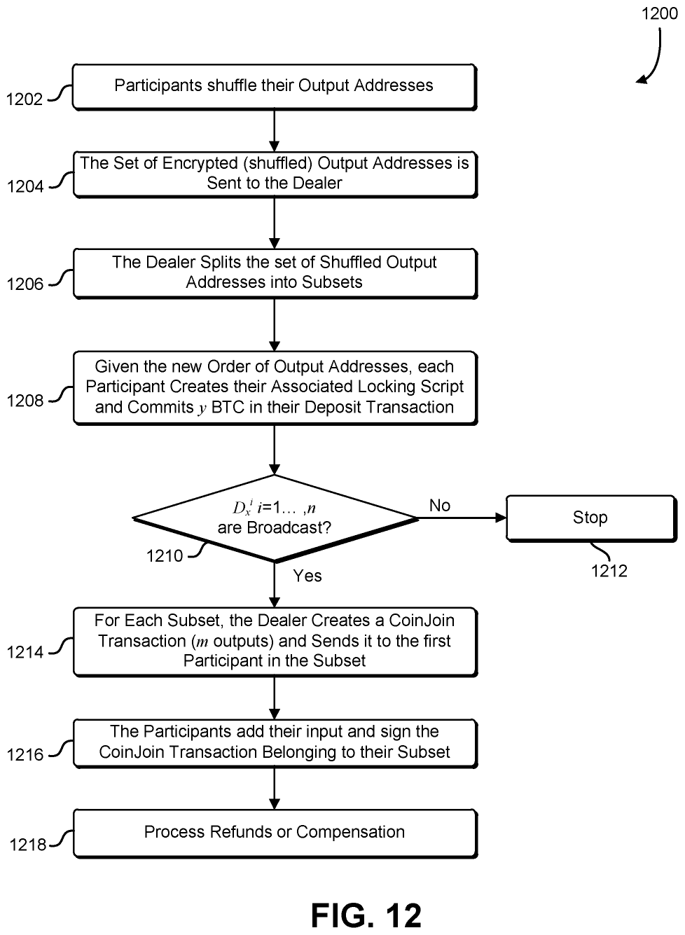

FIG. 12 illustrates an example of a process that, as a result of being performed by a dealer computer system and one or more participant computer systems, rearranges output addresses, generates deposits, and creates CoinJoin transactions for a multi-CoinJoin transaction, in an embodiment. A process 1200 begins at block 1202 with each participant in the multi-CoinJoin transaction performing a shuffle of their output addresses as illustrated in FIG. 4. At block 1204, the set of shuffled output addresses is provided to the dealer computer system. At block 1206, the dealer splits the shuffled output addresses into a plurality of subsets where each subset becomes a Bitcoin transaction. At block 1208, each participant creates their specific locking script as described above and commits an amount of Bitcoin in its deposit transaction to fund the multi-CoinJoin transaction.

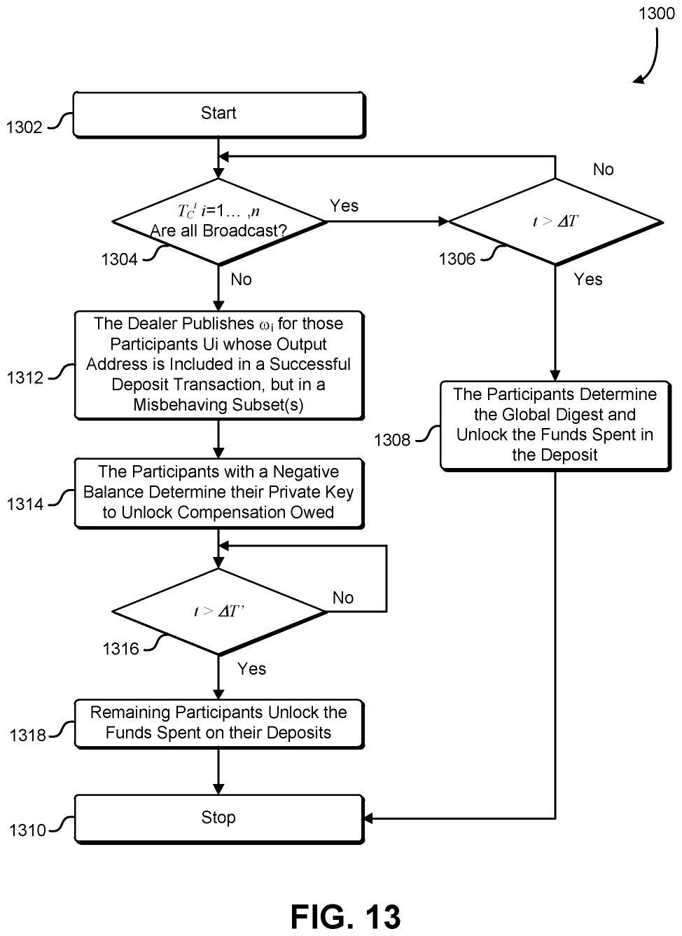

At block 1210, the dealer determines whether the deposits have been committed by all of the participants. If not all of the participants have committed their deposits, after a timeout, execution advances to block 1212 and the multi-CoinJoin transaction is aborted. At block 1214, the dealer computer system creates a CoinJoin transaction for each subset and then sends each transaction to a first participant in that subset. At block 1216, the participants route the transaction amongst themselves and each participant signs their transaction. At block 1218, the dealer determines if any returns or compensation is needed and performs the associated operations as described in FIG. 13.

FIG. 13 illustrates an example of a process that, as a result of being performed by a dealer computer system and one or more participant computer systems, processes returns and compensation for a multi-CoinJoin transaction, in an embodiment. A process 1300 begins at block 1302. At decision block 1304, the dealer computer system determines whether all of the transactions have been broadcast and committed to the blockchain. If all the transactions have been broadcast, execution advances to decision block 1306. At decision block 1306, if a first expiration time is not expired, execution returns to decision block 1304. If the first expiration time has expired, execution advances to block 1308, the participants determine the global digest and unlock the funds committed in the deposit, and execution advances to block 1310 where the process completes.

At decision block 1304, if the dealer computer system determines that all the transactions have been broadcast and committed to the blockchain, execution advances to block 1312 where the dealer publishes the salt for those participants whose output address is included in a successful deposit transaction, but in a misbehaving subset. At block 1314, the participants with a negative balance in the transaction determine their private key and unlock any compensation owed to recover their deposit. At decision block 1316, the system waits until a second expiration time greater than the first expiration time has expired before advancing to block 1318. At block 1318, the remaining participants unlock the funds spent on their deposits, and execution advances to block 1310 where the process completes.

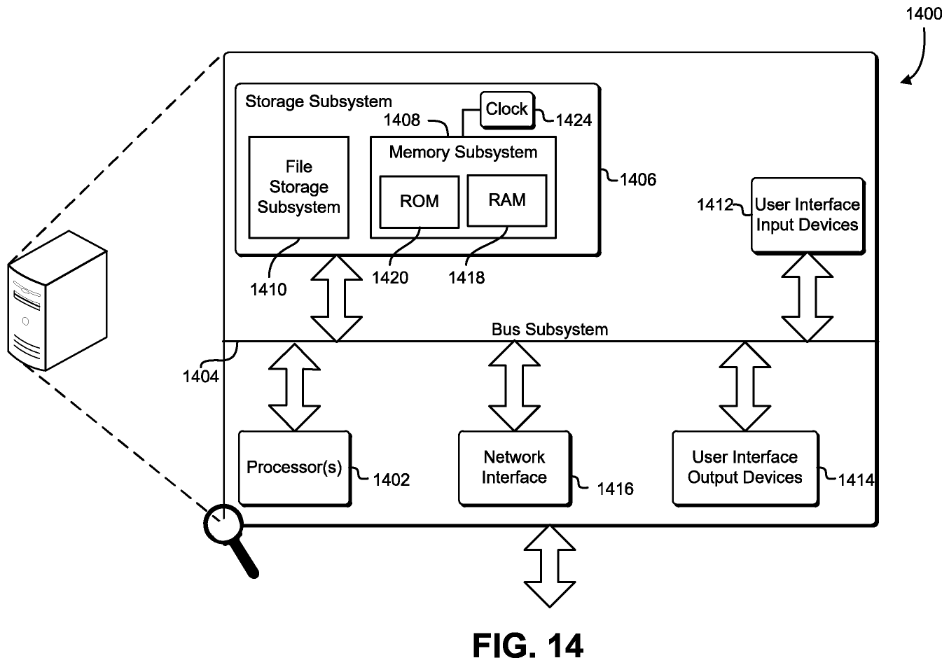

FIG. 14 is an illustrative, simplified block diagram of a computing device 1400 that can be used to practice at least one embodiment of the present disclosure. In various embodiments, the computing device 1400 can be used to implement any of the systems illustrated and described above. For example, the computing device 1400 can be configured for use as a data server, a web server, a portable computing device, a personal computer, or any electronic computing device. As shown in FIG. 14, the computing device 1400 could include one or more processors 1402 that, in embodiments, are configured to communicate with and are operatively coupled to a number of peripheral subsystems via a bus subsystem 1404. In some embodiments, these peripheral subsystems include a storage subsystem 1406 comprising a memory subsystem 1408 and a file/disk storage subsystem 1410, one or more user interface input devices 1412, one or more user interface output devices 1414, and a network interface subsystem 1416. Such storage subsystem 1406 could be used for temporary or long-term storage of information.

In some embodiments, the bus subsystem 1404 provides a mechanism for enabling the various components and subsystems of computing device 1400 to communicate with each other as intended. Although the bus subsystem 1404 is shown schematically as a single bus, alternative embodiments of the bus subsystem utilize multiple busses. In some embodiments, the network interface subsystem 1416 provides an interface to other computing devices and networks. The network interface subsystem 1416, in some embodiments, serves as an interface for receiving data from and transmitting data to other systems from the computing device 1400. In some embodiments, the bus subsystem 1404 is utilised for communicating data such as details, search terms, and so on.

In some embodiments, the user interface input devices 1412 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices.

In some embodiments, the computing device 1400 includes at least one local clock 1424. The local clock 1424, in some embodiments, is a counter that represents the number of ticks that have transpired from a particular starting date and, in some embodiments, is located integrally within the computing device 1400. In various embodiments, the local clock 1424 is used to synchronize data transfers in the processors for the computing device 1400 and the subsystems included therein at specific clock pulses and can be used to coordinate synchronous operations between the computing device 1400 and other systems in a data centre. In another embodiment, the local clock is a programmable interval timer.

1. A computer-implemented method comprising:
generating a data structure that includes compressed information identifying a set of participant computer systems in an output-shuffling process;
acquiring, from the set of participant computer systems, a set of shuffled output addresses;
determining that a set of contribution records corresponding to the set of participant computer systems has been committed to a blockchain;
generating a plurality of transactions based at least in part on the set of shuffled output addresses and the data structure; and
submitting the plurality of transactions to the blockchain.

2. The computer-implemented method according to claim 1, further comprising:
determining, after a first timeout, that an individual transaction associated with a set of individual participant computer systems has failed; and
as a result of determining that an individual transaction has failed, providing cryptographic information to the set of individual participant computer systems that allows the set of individual participant computer systems to claim compensation from the set of contribution records, or reclaim a contribution record of a respective individual participant computer system.

3. The computer-implemented method according to claim 2, wherein:
each set of contribution records includes a locking script; and
the locking script allows a transaction output to be claimed by an individual participant computer system based on the set of shuffled output addresses.

4. The computer-implemented method according to claim 3, further comprising wherein the locking script allows an input to be reclaimed using the cryptographic information.

5. The computer-implemented method according to claim 2, wherein a locking script of a respective contribution record of the set of contribution records allows an input to be reclaimed after a second timeout, the second timeout being greater than the first timeout.

6. The computer-implemented method according to claim 3, wherein the locking script includes an OP_CHECKSEQUENCEVERIFY operator.

7. The computer-implemented method according to claim 1, wherein the set of shuffled output addresses is acquired by causing a set of shuffled output addresses to be routed to each participant computer system in the set of participant computer systems.

8. The computer-implemented method according to claim 1, wherein each contribution record in the set of contribution records includes a transaction fee paid to a dealer that facilitates the computer-implemented method.

9. The computer-implemented method according to claim 1, wherein the data structure is an accumulation tree where leaf nodes of the accumulation tree represent the set of participant computer systems, and a participant computer system has an input address and an output address in the plurality of transactions.

10. The computer-implemented method according to claim 9, wherein participant computer systems in an individual transaction correspond to leaf nodes under an intermediate node of the accumulation tree.

11. The computer-implemented method according to claim 9, wherein each participant computer system provides a hash of a value associated with each leaf node of the accumulation tree.

12. The computer-implemented method according to claim 2, wherein the individual transaction is an asset mixing transaction.

13. The computer-implemented method according to claim 1, wherein each participant computer system is a computer system having one or more processors and memory storing instructions that, as a result of being executed by the one or more processors, implement a cryptocurrency wallet application.

14. A system, comprising:
a processor; and
memory including executable instructions that, as a result of execution by the processor, causes the system to perform the computer-implemented method according to claim 1.

15. A non-transitory computer-readable storage medium having stored thereon executable instructions that, as a result of being executed by a processor of a computer system, cause the computer system to at least perform the computer-implemented method according to claim 1.

16. A system, comprising:
a processor; and
memory including executable instructions that, as a result of execution by the processor, causes the system to perform the computer-implemented method according to claim 2.

17. A system, comprising:
a processor; and
memory including executable instructions that, as a result of execution by the processor, causes the system to perform the computer-implemented method according to claim 3.

18. A system, comprising:
a processor; and
memory including executable instructions that, as a result of execution by the processor, causes the system to perform the computer-implemented method according to claim 4.

19. A non-transitory computer-readable storage medium having stored thereon executable instructions that, as a result of being executed by a processor of a computer system, cause the computer system to at least perform the computer-implemented method according to claim 2.

20. A non-transitory computer-readable storage medium having stored thereon executable instructions that, as a result of being executed by a processor of a computer system, cause the computer system to at least perform the computer-implemented method according to claim 3.
